(19) United States
(12) Patent Application Publication
(10) Pub. No.: US 2021/0199793 A1
(43) Pub. Date: Jul. 1, 2021

(54) METHOD FOR BLUETOOTH LOW ENERGY RF RANGING SEQUENCE

(71) Applicant: Continental Automotive Systems, Inc., Auburn Hills, MI (US)

(72) Inventors: Aaron J. Adler, Rochester Hills, MI (US); Djordje Preradovic, Shelby Township, MI (US); David J. Reimus, Waterford, MI (US); Akshay Choudhari, Troy, MI (US)

(21) Appl. No.: 16/728,495

(22) Filed: Dec. 27, 2019

(51) Int. Cl. G01S 13/76

(52) U.S. Cl. CPC G01S 13/765; G01S 13/762

(57) ABSTRACT

A method of determining a distance between a master device and a remote device includes communicating bi-directionally between a transceiver of a master device and a transceiver of a remote device with Bluetooth Low Energy communication, performing a radio frequency ranging sequence in between an advertising interval or a connection interval of the Bluetooth Low Energy communication, and employing the radio frequency ranging sequence to determine a distance between the master device and the remote device.

### TECHNICAL FIELD

The present disclosure relates to a method for determining a distance between a remote device and a master device, and more particularly to a method that determines the distance by performing a radio frequency (RF) ranging sequence in between an interval of an advertisement sequence or a connection sequence of a Bluetooth Low Energy (BLE) communication.

### BACKGROUND

Individuals often have remote devices such as key fobs, head phones, etc. that are used to provide hands-free access to a master device, such as a vehicle or a cellphone. Access is typically allowed within a certain range or distance of the remote device relative to the master device using a Bluetooth Low Energy communication. The determined distance needs to be accurate.

### SUMMARY

A method of determining a distance between a master device and a remote device according to an exemplary embodiment of this disclosure includes, among other possible things, communicating bi-directionally between a transceiver of a master device and a transceiver of a remote device with Bluetooth Low Energy communication, performing a radio frequency ranging sequence in between an advertising interval or a connection interval of the Bluetooth Low Energy communication, and employing the radio frequency ranging sequence to determine a distance between the master device and the remote device.

In a further embodiment of the foregoing method, the advertising interval or the connection interval is a time between two data transfer events between the master device and the remote device. In a further embodiment of the foregoing method, when the remote device performs an advertising sequence, the advertising interval is between 20 milliseconds and 10.485 seconds. In a further embodiment of the foregoing method, when the remote device performs an a connection sequence, the connection interval is between 7.5 milliseconds and 4 seconds. In a further embodiment of the foregoing method, the radio frequency ranging is at least one of time of flight ranging, phase of flight ranging, angle of arrival ranging, angle of departure ranging, and time difference of arrival ranging. In a further embodiment of the foregoing method, the Bluetooth Low Energy communication and the radio frequency ranging sequencing occur in parallel. In a further embodiment of the foregoing method, the radio frequency ranging sequence is Bluetooth. In a further embodiment of the foregoing method, the radio frequency ranging sequence is Ultra-Wideband. In a further embodiment of the foregoing method, the radio frequency ranging sequence is Wi-Fi. In a further embodiment of the foregoing method, the radio frequency ranging sequence is one or more of Bluetooth, Ultra-Wideband, and Wi-Fi. In a further embodiment of the foregoing method, the master device is a vehicle, and the remote device is a key fob. In a further embodiment of the foregoing method, the master device is a cell phone, and the remote device is headphones.

Another method of determining a distance between a master device and a remote device according to an exemplary embodiment of this disclosure includes, among other possible things, communicating bi-directionally between a transceiver of a master device and a transceiver of a remote device with Bluetooth Low Energy communication and performing a radio frequency ranging sequence in between an advertising interval or a connection interval of the Bluetooth Low Energy communication. The advertising interval or the connection interval is a time between two data transfer events between the master device and the remote device, and the radio frequency ranging sequence is one or more of Bluetooth, Ultra-Wideband, and Wi-Fi. The method also includes employing the radio frequency ranging sequence to determine a distance between the master device and the remote device.

In a further embodiment of the foregoing method, when the remote device performs an advertising sequence, the advertising interval is between 20 milliseconds and 10.485 seconds. In a further embodiment of the foregoing method, when the remote device performs a connection sequence, the connection interval is between 7.5 milliseconds and 4 seconds. In a further embodiment of the foregoing method, the ranging can be at least one of time of flight ranging, phase of flight ranging, angle of arrival ranging, angle of departure ranging, and time difference of arrival ranging. In a further embodiment of the foregoing method, the Bluetooth Low Energy communication and the radio frequency ranging sequencing occur in parallel. In a further embodiment of the foregoing method, the master device is a vehicle, and the remote device is a key fob. In a further embodiment of the foregoing method, the master device is a cell phone, and the remote device is headphones.

These and other features disclosed herein can be best understood from the following specification and drawings, the following of which is a brief description.

### BRIEF DESCRIPTION OF THE DRAWINGS

FIG. 1 is a schematic overhead view of a master device and a remote device communicating with each other using Bluetooth Low Energy communication;

FIG. 2 is a schematic image of a radio frequency ranging sequence performed in between an interval of an advertisement sequence or a connection sequence of a Bluetooth Low Energy communication; and

FIG. 3 is a flow diagram of the method.

### DESCRIPTION

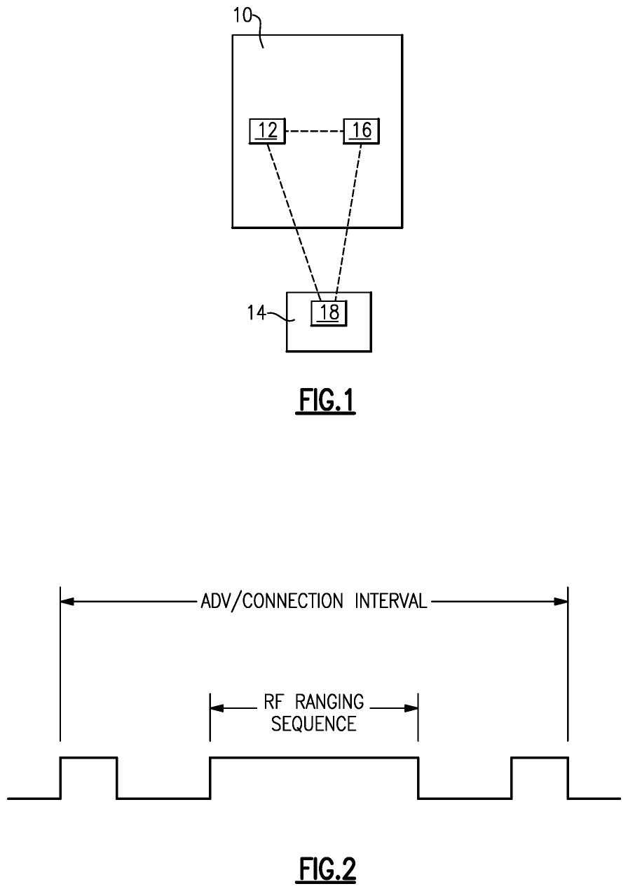

FIG. 1 illustrates a master device 10, such as a vehicle or a cell phone, that includes at least one transceiver 12 that can be placed anywhere within or outside the master device 10. A remote device 14 includes a transceiver 18 that communicates with the transceiver 12. In one example, the master device 10 is a vehicle, and the remote device 14 is a key fob. In another example, the master device 10 is a cell phone, and the remote device 14 is a set of headphones. However, the remote device 14 can be anything, such as a microchip, an asset tag, or any other device configured to provide hands-free or remote keyless access to the master device 10.

A control unit 16 uses distance data to determine an actual distance between the remote device 14 and the master device 10. The control unit 16 can be incorporated as part of the transceiver 12 of the master device 10 or a separate/dedicated control unit 16. The master device 10 can include a processing unit (not shown). The remote device 14 may also include a control unit or a transceiver 18 that is in communication with the control unit 16.

The transceiver 12, the control unit 16, and the transceiver 18 establish communication between the master device 10 and the remote device 14 to implement procedures for authorizing access to the master device 10. The transceiver 18 of the remote device 14 goes to sleep and then wakes up to exchange data with the control unit 12 of the master device 10. Access is typically allowed within a certain range or distance of the remote device 14 relative to the master device 10.

Bi-directional communications between the remote device 14 and the master device 10 determine a distance between the master device 10 and the remote device 14. In one example, the communications are wireless communications that are accomplished via Bluetooth Low Energy. The Bluetooth Low Energy communications can determine a distance between the master device 10 and the remote device 14.

During a Bluetooth Low Energy communication, there is an advertisement sequence and a connection sequence each having an interval. The remote device 14 must advertise first to make a connection with the master device 10.

The interval is a time between two data transfer events (Bluetooth Low Energy connection events) between the master device 10 and the remote device 14. When the remote device 14 is performing the advertising sequence, the advertising interval of the advertising sequence is 20 milliseconds to 10.485 seconds. Once a connection is established, the remote device 14 then performs the connection sequence, and the connection interval of the connection sequence is 7.5 milliseconds to 4 seconds.

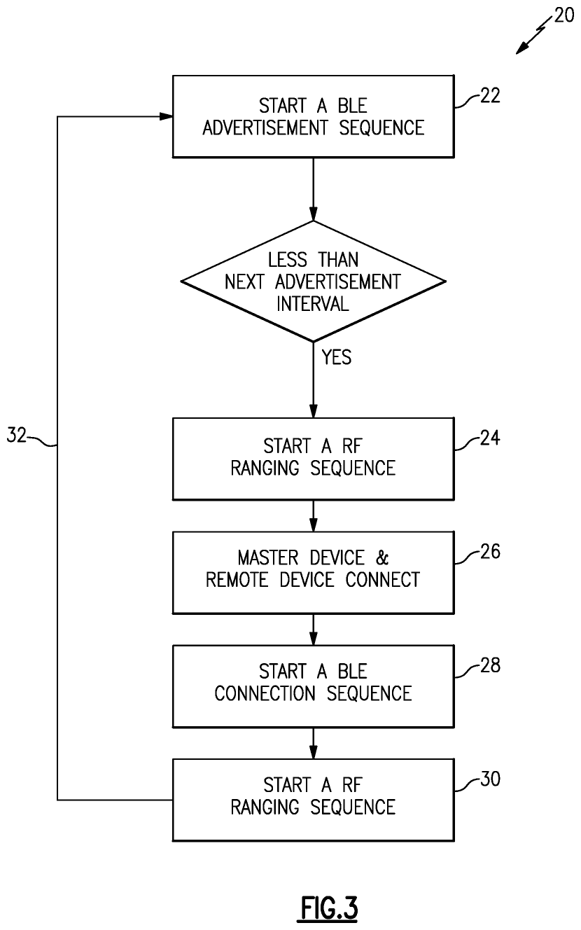

As shown in FIG. 2, a radio frequency ranging sequence is performed in between the advertising interval or the connection interval to determine a distance between the master device 10 and the remote device 14 and to allow the Low Energy Bluetooth connection to remain established.

As shown in the flowchart of FIG. 3, the method 20 includes the step 22 of beginning an advertisement sequence having an advertising interval of 20 milliseconds to 10.485 seconds. In between the advertising interval, the radio frequency ranging sequence begins at the step 24 to determine the distance between the master device 10 and the remote device 14. Once a connection is made between the master device 10 and the remote device 14 at step 26, a connection sequence of a Bluetooth Low Energy communication begins at step 28 having a communication interval of 7.5 milliseconds to 4 seconds. In between the communication interval, the radio frequency ranging sequence begins at the step 30 to determine the distance between the master device 10 and the remote device 14. At step 32, the method repeats, and another advertisement sequence of a Bluetooth Low Energy communication begins.

The radio frequency ranging sequence can be any type of ranging. In one example, the ranging is time of flight ranging, phase of flight ranging, angle of arrival ranging, angle of departure ranging, time difference of arrival ranging, or any other type of ranging.

In one example, the time of flight can be used to find a distance between the master device 10 and the remote device 14. A signal is sent from the master device 10 to the remote device 14, and the signal is used to determine a distance between the master device 10 and the remote device 14. The signal is then sent back from remote device 14 to the master device 10 to find a distance between remote device 14 and the master device 10. The total distance is divided by two to provide the distance between the master device 10 and the remote device 14. During phase of flight, the phase shift is measured during the original transmission from the master device 10 and the remote device 14, and the phase shift is converted to distance.

When off or during sleep time, the transceiver 18 of the remote device 14 wakes up and performs a radio frequency ranging sequence during the Bluetooth Low Energy communication. Any number and duration of the radio frequency ranging sequences can be performed during a Bluetooth Low Energy communication as long as the radio frequency ranging sequences occur in between the advertisement interval or the interval sequence.

By performing the radio frequency ranging sequence in between the advertising interval or the connection interval of a Bluetooth Low Energy communication, a separate radio frequency ranging sequence can operate during downtime of the Bluetooth Low Energy communication. This maintains an active Bluetooth Low Energy communication and does not extending the time of the Bluetooth Low Energy communication. Both the Bluetooth Low Energy communication and the radio frequency ranging sequencing can occur at the same time and in parallel. The master device 10 and the remote device 14 can maintain a Bluetooth Low Energy communication while conducting radio frequency ranging sequencing, and the master device 10 and the remote device 14 can advertise while conducting radio frequency ranging sequencing. The time of the Bluetooth Low Energy communication can be used to do some proprietary ranging.

The radio frequency ranging sequencing can occur in between the advertising interval or the connection interval through several methods that can be implemented in a Bluetooth Low Energy communication. The radio frequency ranging sequencing can be Ultra-Wideband, Wi-Fi, or Bluetooth. In another example, one or more radio frequency ranging sequences can be used. For example, the radio frequency ranging sequence can be performed by one or more of Ultra-Wideband, Wi-Fi, or Bluetooth.

In one example, the control unit 16 or system controller can include a processor, memory, and one or more input and/or output (I/O) device interface(s) that are communicatively coupled via a local interface. The local interface can include, for example but not limited to, one or more buses and/or other wired or wireless connections. The controller may be a hardware device for executing software, particularly software stored in memory. The controller can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The software in the memory may include one or more separate programs, each of which includes an ordered listing of executable instructions for implementing logical functions. The controller can be configured to execute software stored within the memory, to communicate data to and from the memory, and to generally control operations of the computing device pursuant to the software. Software in memory, in whole or in part, is read by the processor, perhaps buffered within the processor, and then executed.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason, the following claims should be studied to determine the true scope and content of this invention.

What is claimed is:

1. A method of determining a distance between a master device and a remote device comprising:
communicating bi-directionally between a transceiver of a master device and a transceiver of a remote device with Bluetooth Low Energy communication;
performing a radio frequency ranging sequence in between an advertising interval or a connection interval of the Bluetooth Low Energy communication; and
employing the radio frequency ranging sequence to determine a distance between the master device and the remote device.

2. The method as recited in claim 1 wherein the advertising interval or the connection interval is a time between two data transfer events between the master device and the remote device.

3. The method as recited in claim 2 wherein when the remote device performs an advertising sequence, the advertising interval is between 20 milliseconds and 10.485 seconds.

4. The method as recited in claim 2 wherein when the remote device performs an a connection sequence, the connection interval is between 7.5 milliseconds and 4 seconds.

5. The method as recited in claim 1 wherein the radio frequency ranging is at least one of time of flight ranging, phase of flight ranging, angle of arrival ranging, angle of departure ranging, and time difference of arrival ranging.

6. The method as recited in claim 1 wherein the Bluetooth Low Energy communication and the radio frequency ranging sequencing occur in parallel.

7. The method as recited in claim 1 wherein the radio frequency ranging sequence is Bluetooth.

8. The method as recited in claim 1 wherein the radio frequency ranging sequence is Ultra-Wideband.

9. The method as recited in claim 1 wherein the radio frequency ranging sequence is Wi-Fi.

10. The method as recited in claim 1 wherein the radio frequency ranging sequence is one or more of Bluetooth, Ultra-Wideband, and Wi-Fi.

11. The method as recited in claim 1 wherein the master device is a vehicle, and the remote device is a key fob.

12. The method as recited in claim 1 wherein the master device is a cell phone, and the remote device is headphones.

13. A method of determining a distance between a master device and a remote device comprising:
communicating bi-directionally between a transceiver of a master device and a transceiver of a remote device with Bluetooth Low Energy communication;
performing a radio frequency ranging sequence in between an advertising interval or a connection interval of the Bluetooth Low Energy communication, wherein the advertising interval or the connection interval is a time between two data transfer events between the master device and the remote device, and the radio frequency ranging sequence is one or more of Bluetooth, Ultra-Wideband, and Wi-Fi; and
employing the radio frequency ranging sequence to determine a distance between the master device and the remote device.

14. The method as recited in claim 13 wherein when the remote device performs an advertising sequence, the advertising interval is between 20 milliseconds and 10.485 seconds.

15. The method as recited in claim 13 wherein when the remote device performs a connection sequence, the connection interval is between 7.5 milliseconds and 4 seconds.

16. The method as recited in claim 13 wherein the ranging can be at least one of time of flight ranging, phase of flight ranging, angle of arrival ranging, angle of departure ranging, and time difference of arrival ranging.

17. The method as recited in claim 13 wherein the Bluetooth Low Energy communication and the radio frequency ranging sequencing occur in parallel.

18. The method as recited in claim 13 wherein the master device is a vehicle, and the remote device is a key fob.

19. The method as recited in claim 13 wherein the master device is a cell phone, and the remote device is headphones.
